(19) United States
(12) Patent Application Publication
(10) Pub. No.: US 2007/0238061 A1
(43) Pub. Date: Oct. 11, 2007

(54) Method for heating a metal material

(75) Inventor: Rudiger Eichler, Taby (SE)

Correspondence Address: ALFRED J MANGELS, 4729 CORNELL ROAD, CINCINNATI, OH, 452412433, US

(73) Assignee: AGA AB, Lidingo (SE)

(21) Appl. No.: 11/418,560

(22) Filed: May 6, 2006

(30) Foreign Application Priority Data
Apr. 11, 2006 (SE) 0600813-0

(51) Int. Cl. F27D 7/00

(52) U.S. Cl. 432/19

(57) ABSTRACT

A method for heating metallic material, such as a slab or a billet, using at least one direct flame impingement burner. The heating power of the flame of the direct flame impingement burner is pulsated in cycles, so that the heating power is alternated between at least two different, predetermined heating powers. Each heating power is maintained during a certain predetermined time period. Some heating powers are lower than others, and the time periods are short enough so that the combination of the heating powers and their corresponding time periods results in not overheating the surface of the metal slab above a predetermined temperature during the time periods of the higher heating powers. The pulsated heating of the metallic material is interrupted when a certain stop condition is fulfilled, and the material is thereafter heated to another predetermined, final, homogenous temperature by the use of another, conventional heating method.

### BACKGROUND OF THE INVENTION

1. Field of the Invention

The present invention relates to the heating of metallic materials, such as metal blanks, parts, and the like, using a direct flame impingement burner.

2. Description of the Related Art

Direct flame impingement burners are used for heating various metallic materials. Instead of heating a volume of the interior of, for example, an industrial furnace, and hence heating a material within the furnace indirectly, the flame is impinged directly upon the surface of the material, thus heating it directly. That approach gives rise to better heat transfer efficiency from the burner flame to the material.

A common type of direct flame impingement burner is the so-called oxyfuel type direct flame impingement burner, which is a burner in which the oxidant has higher oxygen content and lower nitrogen content as compared with air.

When heating using a direct flame impingement burner, the temperature of the surface of the metallic material increases very quickly. Unwanted effects, such as melting, can occur if the heating is allowed to progress during too long a time within the same area of the surface of the metallic material. Today, therefore, direct flame impingement burners are primarily used for heating of metal parts of relatively small cross sections, such as wires, sheets, and smaller billets. As for those metal parts, the temperature throughout the material will have time to reach a sufficient level before the surface of the material deteriorates as a consequence of the intensive heat.

In some cases, the materials are conveyed through the flames of direct flame impingement burners. In case of a stoppage of production, the direct flame impingement burners may have to be shut down in order to prevent the surfaces of the materials from deteriorating.

It would be desirable if the higher efficiency of heat transfer when using direct flame impingement burners could also be used when heating slabs of larger cross sections. However, that is not possible using the known art. Namely, there is not enough time for such slabs to be sufficiently heated throughout the whole volume of the material before the surface of the material deteriorates, for example by melting.

The present invention solves the above-described problem.

### SUMMARY OF THE INVENTION

The present invention relates to a method for heating metallic materials, such as a slab or a billet, using at least one direct flame impingement burner. The heating power of the flame of the direct flame impingement burner is pulsated in cycles, so that the heating power is alternated between at least two different, predetermined heating powers. Each predetermined heating power is maintained during a certain predetermined respective time period, wherein some heating powers are lower than others. The heating powers are low enough, and the time periods are short enough, so that the combination of the heating powers and their corresponding time periods does not heat the surface of the metallic material above a certain, predetermined limit temperature during the time periods of the higher powers. The pulsated heating of the metallic material is interrupted when a certain stop condition is fulfilled. The metallic material is thereafter heated to another predetermined final, homogenous temperature by the use of another, conventional heating method.

### BRIEF DESCRIPTION OF THE DRAWING

The structure, operation, and advantages of the present invention will become further apparent upon consideration of the following description, taken in conjunction with the accompanying drawings in which:

FIG. 1 is a schematic side cross-sectional view of a direct flame impingement burner for heating a metallic material in the form of a slab in accordance with an embodiment of the method of the present invention; and

FIG. 2 is a heating-time diagram showing the heating power as a function of time for the direct flame impingement burner of FIG. 1, in accordance with an embodiment of the method of the present invention.

### DESCRIPTION OF THE PREFERRED EMBODIMENTS

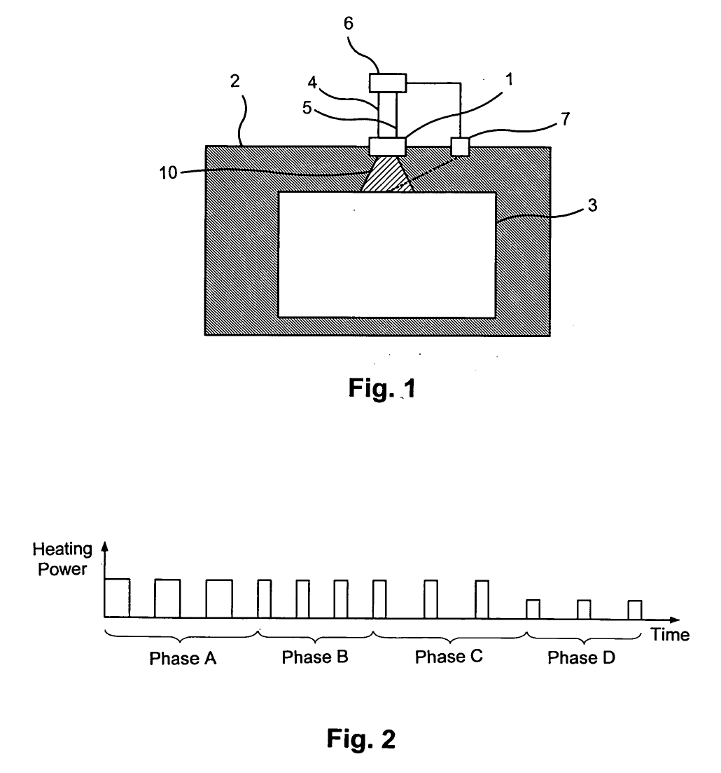

FIG. 1 shows an oxyfuel-type direct flame impingement burner 1. The burner is arranged in the interior of an industrial furnace 2 in such a way that its flame 10 is made to impinge directly upon a metallic material 3, such as in the form of a slab, which is also arranged within the interior of the furnace 2. The metallic material 3 is large enough so that the continuous heating of the whole volume of the metallic material 3 up to a certain desired, predetermined temperature profile using the direct flame impingement burner 1, would lead to deterioration of the surface of the metallic material 3, for example by melting. Preferably, the metallic material is in the form of a slab having a weight of between 10 and 160 tons.

The direct flame impingement burner 1 is provided with a supply inlet 4 for fuel and a supply inlet 5 for oxidant. The fuel can be any suitable fuel, for example a gaseous fuel such as natural gas, a liquid fuel such as oil, or a solid fuel such as pulverized coal. The oxidant can be any suitable gaseous oxidant. According to a preferred embodiment, the oxygen content of the oxidant is at least 85% by weight.

The supply inlets 4, 5 are connected to a control unit 6, which is configured to continuously control the supply of fuel and oxidant. The control unit 6 is also connected to a temperature sensor 7 that is positioned within the interior of the furnace.

The temperature sensor 7 is arranged to pyrometrically measure the temperature of the part of the surface of the metallic material 3 being impinged by the flame 10 of the direct flame impingement burner. The measured value of the surface temperature is continuously transmitted to the control unit 6.

The control unit 6 is thus arranged to control the heating power of the direct flame impingement burner 1, through the control of the amount of fuel and oxidant, respectively, being supplied to the direct flame impingement burner 1 at any given moment in time through the supply inlets 4, 5. That control takes place in the present embodiment by the simultaneous proportional increase or decrease of both the amount of fuel and the amount of oxidant.

In the present embodiment, the control is carried out such that the heating power of the direct flame impingement burner 1 alternates between two different states: one state having a higher heating power and one state having a lower heating power. The lower heating power can, in effect, be zero. In other words, the direct flame impingement burner 1 can be switched off when the lower power prevails, and it is reignited when the higher power commences. However, it is possible to use more than two different, alternating heating power states, and those heating power states can each be associated with any suitable heating power value between zero and the maximum heating power of the direct flame impingement burner. For example, it is possible that a lower heating power state is such that only a pilot-type flame is burning, so that the burner 1 does not need to be reignited when leaving the lower power state.

In the following description, the term “turned-on state” denotes the higher heating power state of the present embodiment, and the term “turned-off state” denotes the lower heating power state in the present embodiment. A method alternating between at least one turned on state and at least one turned off state is herein denoted by the term “on/off operation.”

Each heating power state is associated with a corresponding time period. Thus, the control unit 6 is made to control the supply of fuel and oxidant, respectively, to the direct flame impingement burner 1, so that the turned-on state is made to prevail during a certain first time period, after which the turned-off state is made to prevail during a certain second time period, after which the turned-on state is made to prevail during the first time period again, and so on, in an alternating manner.

During the first time period, the metallic material 3 is heated. Had the turned-on state been maintained during a longer time, the surface of the metallic material 3 would have finally deteriorated as a consequence of the too elevated temperature. However, the turned off-state is commenced before such surface damage can occur.

In the description below, the control of the heating power of the direct flame impingement burner 1 over time in the present embodiment will be explained in greater detail with reference to FIG. 2, which shows a schematic diagram of the emitted heating power of the direct flame impingement burner 1 as a function of time from the beginning of the operation.

At the start of the heating operation, the metallic material 3 maintains a certain known, homogenous temperature, for example 600° C. To start with, the heating power of the turned-on state is made to be the full heating power of the direct flame impingement burner. The length of the second time period is made to be long enough, as compared with the length of the first time period, in order for the surface of the metallic material 3 to cool down enough, by means of heat being conducted from the surface down into the material during the turned-off state, so that the surface is not heated above a certain predetermined, maximum surface temperature during the next time period of a turned-on state. That maximum surface temperature is herein denoted by the term “limit temperature.”

The limit temperature is, for example, set so that it is just below the temperature desired to be the final temperature throughout the whole volume of the metallic material 3. If, for example, a slab is to be heated to 1225° C., the limit temperature is set to 1225° C. −X° C., where X, by way of example, is 100, or another suitable security margin. However, the limit temperature can be set to any other temperature suitable for the specific purposes of the method according to the present invention, such as just below the melting point of the metallic material 3, or just below the melting point of an oxide scale that carried on the surface of metallic material 3.

Initially, the lengths of both of the time periods can be set based upon an empirical investigation using the same type of metallic material 3 which will be heated, the type of industrial furnace 2 that is employed, the initial temperature of the metallic material 3, and the like. The lengths of the initial time periods can also be dynamic in the sense that their respective heating power states are maintained up until the point where a certain predetermined condition is fulfilled.

Thus, the surface of the metallic material 3 is heated during the turned-on state. During the turned-off state, the heat is conducted from the surface region of the metallic material 3 down into the interior parts of the metallic material 3, and thus heats the rest of the volume of the metallic material 3 via thermal conduction, at the same time as the surface layer of the metallic material 3 cools down. For each alternating cycle between the turned-on state and the turned-off state, the inner volume of the metallic material 3 is further increasingly heated, whereby the average temperature, over a complete cycle, of its surface layer consequently also increases.

This initial, alternating process is shown graphically in FIG. 2 as “Phase A.” Exemplifying values during Phase A is 15 seconds for the first time period (the turned-on state), and 15 seconds for the second time period (the turned-off state).

The control unit 6 continuously obtains from the temperature sensor 7 information on the average surface temperature of the metallic material 3. As the average surface temperature exceeds a certain first, predetermined value, the control unit 6 shifts modes, so that the time period of the turned-on state is shortened in each alternating cycle. This is denoted in FIG. 2 as “Phase B.” That shortening of the time period of the turned-on state will result in the surface of the metallic material 3 being heated less during every subsequent first time period in which the turned-off state prevails, and its temperature does not reach the predetermined limit temperature during the turned-on state, albeit the higher interior temperature of the metallic material 3 relative to the initial temperature, as compared with during the beginning of Phase A.

As the average surface temperature exceeds a certain second predetermined value, the control unit 6 shifts modes, so that, additionally, the time period of the turned-off state is extended in each subsequent alternating cycle. That time extension is denoted in FIG. 2 as “Phase C.” The elongation of the time period of the turned-off state allows the surface of the metallic material 3 to cool down to a greater extent during the turned-off state, as compared with the cooling in Phase B during the turned-off state, in order to ensure that the surface of the metallic material 3 still does not exceed the predetermined limit temperature in the following cycle.

As the average surface temperature surpasses a certain third predetermined value, the control unit 6 shifts modes so that the heating power during the turned-on state is reduced, for example to half of the maximum heating power of the direct flame impingement burner, which further reduces the heating during the turned-on state. That is denoted in FIG. 2 as “Phase D.”

Phase D is maintained, with its moderate heating power, until the average surface temperature of the metallic material 3 reaches a certain predetermined value. Alternatively, Phase D is maintained during a certain predetermined time period. The predetermined, average surface temperature or the predetermined time period can be empirically determined, based upon the type of material being heated, the desired final, homogenous temperature, and the like

In order to reach a predetermined, final, homogenous temperature in the entire volume of the metallic material 3, another, secondary heating method is subsequently employed, for example using a furnace with a conventional burner, to finish the heating of the metallic material 3. For example, if the desired, final, homogenous temperature is 1225° C., the secondary heating step is maintained until that temperature has been reached throughout the entire volume of the metallic material 3.

Thus, in the method described above with reference to Phase A, Phase B, Phase C, and Phase D, the corresponding heating power values and/or the corresponding time periods over successive cycles are changed, so that the higher heating power value is reduced, the time period corresponding to the lower heating power value is lengthened, and/or the time period corresponding to the higher heating power value is shortened, so that the average heating power impinged upon the surface of the metallic material 3 during a subsequent cycle is less than the average heating power during a previous cycle.

However, the control unit 6 is not limited to performing a control such as the one described in conjunction with the phases A, B, C, and D. Rather, any suitable control arrangement can be used, where the heating power values and/or their corresponding time periods are changed over successive cycles, so that higher and/or lower heating power values are reduced, time periods corresponding to lower heating power values are lengthened, and/or time periods corresponding to higher heating power values are shortened, so that the average heating power impinged upon the surface of the metallic material 3 during a subsequent cycle is less than the average heating power during a previous cycle.

In the described embodiment, power values and/or their corresponding time periods are changed as a function of the instantaneous surface temperature of the metallic material 3.

However, the control can be carried out based not only on the instantaneous surface temperature of the metallic material 3, which is read by a pyrometer, but also on other parameters, such as, for example, calculations and/or values based upon experience. Also, another type of temperature sensor can be used instead of a pyrometer, such as, for example, a thermocamera.

Also, the present method can be used as a complement to other heating methods, for example in an industrial furnace, together with other heating apparatus. One example of this is the use in a car-type furnace, for the heating of a bloom, in which case the furnace is heated using its proper, conventional heating elements or burners. In that case, additional burners are positioned for heating in accordance with the method of the present invention, for example in the arc or in the lower part of the furnace, pointed directly at the bloom. The slabs can be charged cold or preheated.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A method for heating metallic materials, such as a slab or a billet, using at least one direct flame impingement burner, said method comprising the steps of: pulsating the heating power of a flame of the direct flame impingement burner in cycles, so that the heating power is alternated between at least two different, predetermined heating powers; maintaining each predetermined heating power during a respective predetermined time period, wherein some heating powers are lower than others; maintaining the heating powers sufficiently low and maintaining the time periods sufficiently short so that the combination of the heating powers and their corresponding time periods results in not heating the surface of the metallic material above a predetermined limit temperature during the time periods of higher heating powers; interrupting pulsated heating of the metallic material when a predetermined stop condition is fulfilled; and thereafter heating the metallic material to another predetermined final, homogenous temperature by the use of another heating method.

2. A method in accordance with claim 1, wherein the stop condition is defined as a time when an average temperature of the surface of the metallic material over a complete cycle exceeds a certain predetermined value.

3. A method in accordance with claim 1, wherein the stop condition is defined as a period of time from the commencement of the method.

4. A method in accordance with claim 1, including the step of controlling fuel and oxidant supplied to the direct flame impingement burner to provide different predetermined heating power values.

5. A method in accordance with claim 1, including the step of employing an on/off operation to control heating power provided by the direct flame impingement burner.

6. A method in accordance with claim 1, wherein the limit temperature is lower than the melting point temperature of the metallic material.

7. A method in accordance with claim 1, wherein the limit temperature is lower than the melting point temperature of an oxide scale carried by the metallic material.

8. A method in accordance with claim 1, wherein the limit temperature is lower than the predetermined final, homogenous temperature of the metallic material.

9. A method in accordance with claim 1, including the step of changing at least one of heating power values and time periods over successive cycles so that higher or lower heating power values are reduced, or so that time periods corresponding with lower heating power values are lengthened or time periods corresponding to higher heating power values are shortened, so that an average heating power applied to the surface of the metallic material over a subsequent cycle is less than an average heating power applied over a previous cycle.

10. A method in accordance with claim 9, including the step of changing at least one of heating power values and corresponding time periods as a function of an instantaneous surface temperature of the metallic material.

11. A method in accordance with claim 4, wherein the oxidant has an oxygen content of more than 85% by weight.

12. A method in accordance with claim 1, wherein the direct flame impingement burner is used in an industrial furnace in cooperation with other heating apparatus.
